(19) United States
(12) Patent Application Publication
(10) Pub. No.: US 2007/0068924 A1
(43) Pub. Date: Mar. 29, 2007

(54) Virtual hearth design system

(75) Inventors: Eric Paul Hawkinson, Prior Lake, MN (US); Bradley Dean Determan, Lakeville, MN (US); Randy Wendolek, Eagan, MN (US); Thomas J. Bachinski, Lakeville, MN (US)

Correspondence Address: FAEGRE & BENSON, LLP;PATENT DOCKETING, 90 SOUTH SEVENTH STREET, 2200 WELLS FARGO CENTER, MINNEAPOLIS, MN, 55402, US

(73) Assignee: Hearth & Home Technologies, Inc., Lakeville, MN (US)

(21) Appl. No.: 11/238,652

(22) Filed: Sep. 28, 2005

(51) Int. Cl. B23K 13/08

(52) U.S. Cl. 219/482

(57) ABSTRACT

A method and system for simulating a living space capable of receiving a heating appliance. The method includes loading onto a computer system or a computer readable medium data representing at least a portion of the living space. The method further includes selecting from a data storage device or the computer readable medium data representing at least one heating appliance from a group of heating appliance simulations. The method also includes combining the data representing the at least one heating appliance with the data representing the at least a portion of the living space to generate data representing a simulated living space with the at least one heating appliance received therein.

### BACKGROUND

1. Field of the Invention

The present invention generally relates to heat generating appliances, and more specifically relates to systems and methods for displaying components and accessories of a heat-generating appliance.

2. Related Art

Heating appliances such as fireplaces, stoves and fireplace inserts have become increasingly commonplace in homes, businesses, and other buildings. These and other types of heating appliances provide an aesthetically pleasing arrangement of, for example, flames, sounds, and smells in addition to the generation of heat. Such heating appliances are typically mounted in a wall structure or directly adjacent to a wall structure and may include one or more surfaces exposed in a living space. Accessories such as surrounds, mantles, grates, decorative panels, and doors may be added to a heating appliance to further enhance aesthetic and functional aspects of the heating appliance.

There are often many considerations related to the installation of a heating appliance. For example, the type (e.g., fireplace, stove, fireplace insert), style (modern, traditional, ornate), and size of the heating appliance are all selectable options for a consumer. Further, accessories such as surrounds, mantels and doors, or other decor such as the paint, brick, tile, stone and molding surrounding the heating appliance are considerations when installing a heating appliance. The selection by a consumer among these many alternatives to create a desired result can be difficult. Merely viewing actual fireplace products and accessories as separate objection, for example, in a retail store is an inadequate solution for many consumers.

### SUMMARY

The present invention relates to systems and method for simulating decorative heating appliances, accessories for the decorative heating appliance, and combinations of the decorative heating appliances with the accessories. The present invention also related to simulating living spaces with a decorative heating appliance and related accessories exposed therein. The present invention further relates to combining simulated objects such as a decorative heating appliance, related accessories, or portions of a living space, with actual objects such a decorative heating appliances, related accessories, and portions of living spaces. The present invention yet further relates to displaying the simulated objects described above in true to live scale using, for example, projections, large TV screens or monitors. The present invention still further relates to displaying portions of the simulated objects and combinations of objects using video, sound, lighting, and other multi-media resources to provide enhanced realism of the simulated objects.

One aspect of the invention relates to a method of simulating a living space capable of receiving a heating appliance. The method includes loading onto a computer system or a computer readable medium data representing at least a portion of the living space. The method further includes selecting from a data storage device or the computer readable medium data representing at least one heating appliance from a group of heating appliance simulations. The method also includes combining the data representing the at least one heating appliance with the data representing the at least a portion of the living space to generate data representing a simulated living space with the at least one heating appliance received therein.

Another aspect of the invention relates to a fireplace simulation system that includes a data storage device, a processor, and a display device. The data storage device is configured to store data representing at least one heating appliance and at least one heating appliance accessory. The processor is configured to combine data representing the at least one heating appliance and the at least one heating appliance accessory, and configured to generate data representing a simulated hearth. The display device is configured to display the simulated hearth.

A further aspect of the invention relates to a method of displaying a simulated hearth image. The method includes selecting a heating appliance image from a group of electronically stored heating appliance images, and selecting at least one accessory image from a group of electronically stored heating appliance accessory images. The method also includes combining data representing the selected heating appliance image and the selected accessory image to generate a simulated hearth image, and displaying the simulated hearth image in a 1:1 scale representative of an actual heating appliance represented by the heating appliance images.

A still further aspect of the invention relates to a method of simulating fireplace accessories with a fireplace, wherein the fireplace is exposed in a living space.

The method includes selecting data representing a fireplace accessory from data representing a group of fireplace accessories, generating an image of the fireplace accessory from the selected data, and projecting the image of the fireplace accessory into the living space to simulate the fireplace accessory in combination with the fireplace.

Another aspect of the invention relates to a computer-readable medium having computer-executable instructions for performing steps of storing, according to user inputs, data representing at least one heating appliance and data representing at least one heating appliance accessory, and combining the data representing the at least one heating appliance with the data representing the at least one heating appliance accessory to generate data representing a simulated hearth having the appearance of the at least one heating appliance in combination with the at least one heating appliance accessory.

The above summary of the present invention is not intended to describe each disclosed embodiment or every implementation of the present invention. In particular, the example embodiments described below in relation to the Figures are the application of the present invention to heating appliances, whereas many other fields may be applicable to fulfill the purposes and intents of the present invention. Figures in the detailed description that follow more particularly exemplify certain embodiments of the invention. While certain embodiments will be illustrated and describe embodiments of the invention, the invention is not limited to use in such embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic diagram representing components of an example heating appliance simulation system according to principles disclosed herein;

FIG. 2 is an exploded perspective view of an example fireplace with fireplace accessories for mounting to a wall structure of a living space;

FIG. 3 illustrates an example general purpose computing system;

FIG. 4 is a schematic diagram representing basic system requirements for an example heating appliance simulation system according to principles disclosed herein;

FIG. 5 is a schematic diagram representing basic system requirements for another example heating appliance simulation system according to principles disclosed herein;

FIG. 6 is a schematic diagram representing basic system requirements for a yet further example heating appliance simulation system according to principles disclosed herein;

FIG. 7 is a flow diagram showing some example process step according to a method of simulating a living space capable of displaying a heating appliance therein according to principles disclosed herein;

FIG. 8 is a flow diagram showing some example process step according to a method of displaying a simulated hearth image according to principles disclosed herein;

FIG. 9 is a flow diagram showing some example process step according to a method of simulating fireplace accessories with a fireplace according to principles disclosed herein; and

FIG. 10 is a flow diagram showing some example process step related to a computer-readable medium having computer-executable instructions for performing steps according to principles disclosed herein.

While the invention is amenable to various modifications and alternate forms, specifics thereof have been shown by way of example and the drawings, and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The present invention generally relates to decorative heating appliances, and more specifically relates to systems and methods of simulating heating appliances, accessories for heating appliances, and living spaces capable of receiving and displaying the heating appliances and accessories. The examples systems and related methods disclosed herein are merely representative of the many applications of the inventive principles that are possible.

An example application relates to simulating living spaces with a simulated decorative heating appliances and related accessories exposed therein. Another example application relates to combining simulated objects such as a decorative heating appliance, related accessories, or portions of a living space, with actual objects such a decorative heating appliances, accessories, and portions of living spaces. A further example application relates to displaying the simulated objects described above in true to live scale using, for example, projections, large TV screens or monitors. A yet further example application relates to displaying portions of the simulated objects and combinations of objects using video, sound, lighting, and other multi-media resources to provide enhanced realism of the simulated objects. The combining of data representing actual and simulated objects, as well as the display of the data as images may be performed at different locations such as, for example, a retail store or in a consumer's home. Additional examples, including combinations of those examples listed above, are described below with reference to the attached Figures.

As used herein, the term “living space” will be understood to mean the interior or inner portion of any dwelling structure, such as a house or office building that at least partially protects from the elements. The term “room” is defined as an area of the living space in which the heating appliance resides. In some cases, the term “living space” is more broadly defined as any area in which persons dwell or live. For example, a “living space” may include a defined space such as an outdoor patio or deck wherein persons dwell and heating appliances are capable of residing.

The term “heating appliance” is defined as a device or system that generates heat or simulates generation of heat. A “decorative heating appliance” more particularly relates to heating appliances that provide an aesthetic function/purpose. Some example decorative heating appliances include fireplaces, stoves, fireplace inserts, fire pits, and the like. Decorative heating appliances may generate a flame or a simulated flame and may have a structure that is ornamental, thereby providing an aesthetic purpose in addition to a heating function.

The present invention is described in conjunction with decorative heating appliances, which include, for example, fireplaces, stoves, and fireplace inserts. Some example fireplaces include direct vent, universal vent, B-vent, horizontal/vertical-vent, dual direct vent, and multisided fireplaces having two or three glass panels as combustion chamber side panels, for both gas and wood burning units having open or closed fronts. Principles of the present invention may be equally applicable to gas, wood burning, and pellet stoves, inserts, furnaces, and similar heat generating appliances that provide a decorative aspect such as a decorative flame or added ambiance for a living space.

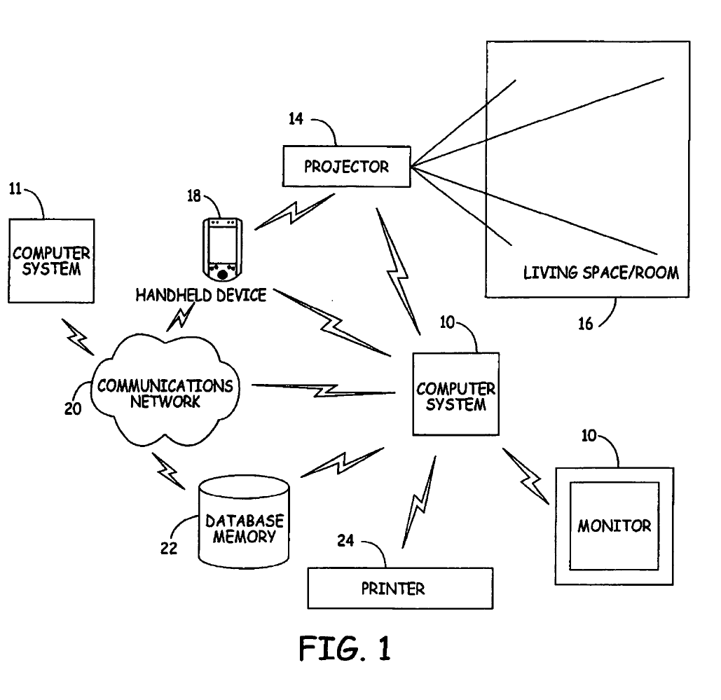

Referring now to FIG. 1, an example system 8 for simulation of hearth related objects and the living spaces within which the hearth related objects reside is shown. The system 8 includes a computer system 10, a monitor 12, a projector 14, and a portion of the living space 16. The system 8 also includes a handheld device 18, a communications network 20, a database/memory 22, and a printer 24. In a basic form, the system 8 may include at least the computer system 10 and some type of display or output device such as the monitor 12, projector 14, handheld device 18, or printer 24. Additional features and functionality may be included in system 8 or in other embodiments to provide for communication, storage, processing, and display functions.

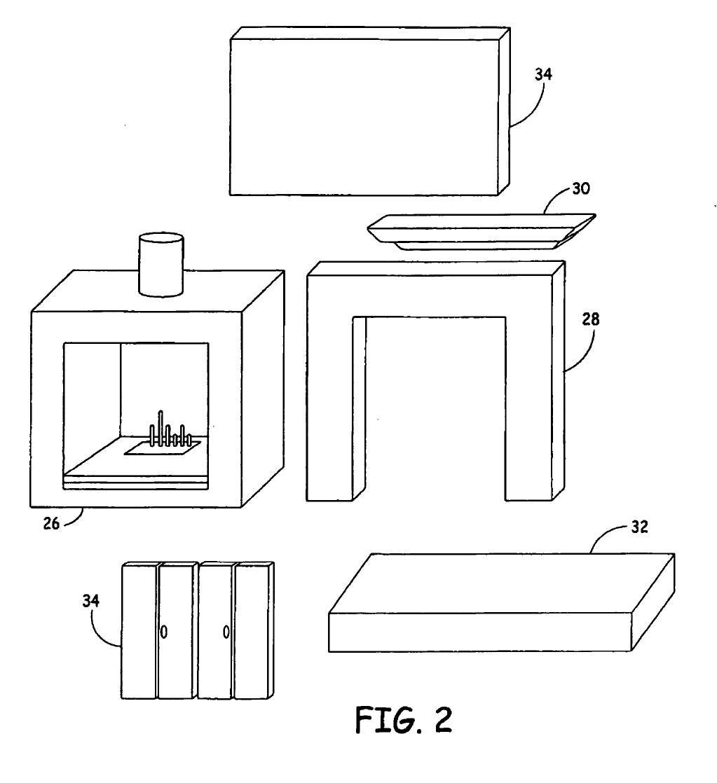

Some example hearth related objects include, with reference to FIG. 2, a fireplace 26 or other decorative heating appliance, a surround 28, a mantel 30, a hearth member, a portion of a living space such as wall structure 34, and doors 36. Other hearth related objects not illustrated by which are equally applicable include, for example, grates, log sets, lighting fixtures, ember beds, simulated flame displays, holographic images/screens, wall systems, shelves, cabinets, etc. The system 8 is configured to combine data representing one or more the objects illustrated in FIG. 2 and the additional accessories listed above with data representing other heating appliances, heating appliance accessories or portions of a living space. The system 8 is also configured to display the data representing those objects in a variety of ways including, for example, on the monitor 12, onto a wall or screen as a projection 15 using projector 14, on a handheld device, or output via printer 24 on a printed medium such as papers. The data representing the hearth related objects can be communicated electronically via, for example, the communications network 20 to any of the devices 10, 12, 14, 18, 20 and 24. The data may also be stored in database/memory 22 locally (e.g., in close proximity to the computer system 10) or at a location remote from the computer system 10 and the other devices 12, 14, 18, 24.

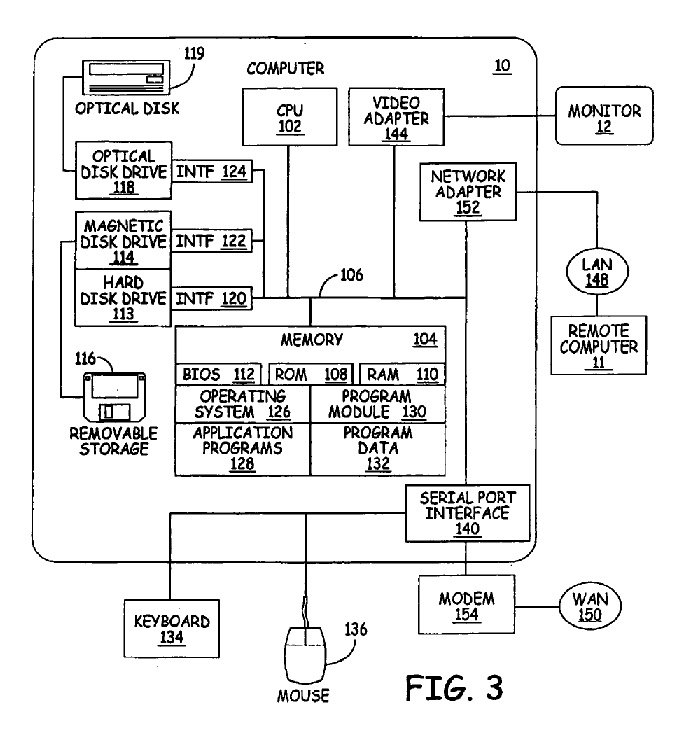

The computer system 10 may include a variety of commonly known features as described with reference to FIG. 3. The computer system 10 illustrated in FIG. 3 can take a variety of forms such as, for example, a desktop computer, a laptop computer, and a handheld computer. In addition, although computer system 10 is illustrated, the systems and methods disclosed herein can be implemented in various alternative computer systems as well.

The computer system 10 includes a processor unit 102, a system memory 104, and a system bus 106 that couples various system components including the system memory 104 to the processor unit 102. The system bus 106 can be any of several types of bus structures including a memory bus, a peripheral bus and a local bus using any of a variety of bus architectures. The system memory includes read only memory (ROM) 108 and random access memory (RAM) 110. A basic input/output system 112 (BIOS), which contains basic routines that help transfer information between elements within the computer system 10, is stored in ROM 108.

The computer system 10 further includes a hard disk drive 113 for reading from and writing to a hard disk, a magnetic disk drive 114 for reading from or writing to a removable magnetic disk 116, and an optical disk drive 118 for reading from or writing to a removable optical disk 119 such as a CD ROM, DVD, or other optical media. The hard disk drive 113, magnetic disk drive 114, and optical disk drive 118 are connected to the system bus 106 by a hard disk drive interface 120, a magnetic disk drive interface 122, and an optical drive interface 124, respectively. The drives and their associated computer-readable media provide nonvolatile storage of computer readable instructions, data structures, programs, and other data for the computer system 10.

Although the example environment described herein can employ a hard disk 113, a removable magnetic disk 116, and a removable optical disk 119, other types of computer-readable media capable of storing data can be used in the example system 10. Examples of these other types of computer-readable mediums that can be used in the example operating environment include magnetic cassettes, flash memory cards, digital video disks, Bernoulli cartridges, random access memories (RAMs), and read only memories (ROMs).

A number of program modules can be stored on the hard disk 113, magnetic disk 116, optical disk 119, ROM 108, or RAM 110, including an operating system 126, one or more application programs 128, other program modules 130, and program data 132.

A user may enter commands and information into the computer system 10 through input devices such as, for example, a keyboard 134, mouse 136, or other pointing device. Examples of other input devices include a toolbar, menu, touch screen, microphone, joystick, game pad, pen, satellite dish, and scanner. These and other input devices are often connected to the processing unit 102 through a serial port interface 140 that is coupled to the system bus 106. Nevertheless, these input devices also may be connected by other interfaces, such as a parallel port, game port, or a universal serial bus (USB). An LCD display 142 or other type of display device is also connected to the system bus 106 via an interface, such as a video adapter 144. In addition to the display 142, computer systems can typically include other peripheral output devices (not shown), such as speakers and printers.

The computer system 10 may operate in a networked environment using logical connections to one or more remote computers, such as a remote computer 11. The remote computer 11 may be a computer system, a server, a router, a network PC, a peer device or other common network node, and typically includes many or all of the elements described above relative to the computer system 10. The network connections include a local area network (LAN) 148 and a wide area network (WAN) 150. Such networking environments are commonplace in offices, enterprise-wide computer networks, intranets, and the Internet.

When used in a LAN networking environment, the computer system 10 is connected to the local network 148 through a network interface or adapter 152. When used in a WAN networking environment, the computer system 10 typically includes a modem 154 or other means for establishing communications over the wide area network 150, such as the Internet. The modem 154, which can be internal or external, is connected to the system bus 106 via the serial port interface 140. In a networked environment, program modules depicted relative to the computer system 10, or portions thereof, may be stored in the remote memory storage device. It will be appreciated that the network connections shown are examples and other means of establishing a communications link between the computers may be used.

The embodiments described herein can be implemented as logical operations in a computing system, such as the computer system 10. The logical operations can be implemented (1) as a sequence of computer implemented steps or program modules running on a computer system and (2) as interconnected logic or hardware modules running within the computing system. This implementation is a matter of choice dependent on the performance requirements of the specific computing system. Accordingly, the logical operations making up the embodiments described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium and may also be encoded within a carrier-wave signal for transmission between computing devices.

The monitor 12 provides a viewing screen for display of hearth related images and data representing hearth related objects from the computer system 10. The monitor 12 may be, for example, a cathode ray tube (CRT), a liquid crystal (LCD), plasma, or other type of display device. Monitor 12 may have any size ranging from, for example, a minute viewing screen to a screen size to illustrate true to life scale of hearth related objects. The monitor 12 may be fixed to any given locations such as, for example, a retail store, or may be a mobile device to provide viewing and display of hearth related objects at a remote site such as, for example, a consumer's home, a trade show display, etc.

The projector 14 is configured to project images from a small scale to a larger scale. The projector 14 provides a projection 15 on to a surface such as, for example, a display screen, a wall structure of a living space, or a hearth related object such as a decorative heating appliance or an accessory for the decorative heating appliance as described with reference to FIG. 2 above. In some embodiments, the projection 15 may be a 3-dimensional projection into open space. In a yet further embodiment, the screen on to which the projection 15 is displayed may be a holographic, lenticular, or other type of screen configuration that provides enhanced depth or the appearance of movement in the projection. An example lenticular device associated with hearth related objects is described in U.S. Pat. No. 6,880,275 and entitled Lenticular Fireplace, which patent is incorporated herein by reference.

In one example embodiment, the projector 14 projects an image or other data representing a portion of a consumer's living space onto the wall structure 16, wherein a fireplace is mounted to the wall structure 16. This embodiment provides for a combination of actual objects (the fireplace) with a simulation (the consumer's living space). In a similar embodiment, the projector projects an image of or data representing a fireplace as projection 15 onto a wall structure or other portion of a consumer's living space in the consumer's home. The image of or data representing the fireplace can be combined with an image of or data representing other hearth related features such as a surround, mantel, doors, etc. and also projected onto the consumer's wall structure or other living portion of their living space. This provides the consumer with an improved visual understanding of how their living space will look with the addition of the decorative heating appliance (e.g., fireplace) and other hearth related accessories after installation of the actual product.

The handheld device 18 may include at least some of the functionality of the computer system 10. The handheld device 18 can also include a small display, memory, wired or wireless communication capabilities, photograph and projector capabilities, and many other features. The handheld device can provide advantages of compactness, ease of transport and multi-functionality. The communications network 20 may include a local area network (LAN) as well as connections to external networks such as the World Wide Web, satellite communications, cellular communications, etc. The communications network 20 communicates with the computer system 10 and may further be capable of communicating with devices 12, 14, 18, 22, 24, and related devices such as another computer system 11 that is located somewhere remote from the computer system 10 (e.g., in a different store, or a mobile unit positioned in a consumer's home while the computer system 10 is located at a retail store.)

The communications network 20 may be in communication with the database/memory and act as a communication throughput between the database/memory and the computer system 10 for uploading or downloading relevant information. In one example, the database/memory 22 may include new data representing additional heating appliance embodiments or heating appliance accessories that is downloaded to the computer system 10 via the communications network 20. The database/memory 22 may also act as a storage device for storing information about the activities and functions of the computer system 10. Such information may be useful for diagnosing problems, monitoring usage time for maintenance purposes, determining the popularity of certain hearth related features such as a given fireplace model, the location of the computer system 10, or the number of uses at different locations. The database/memory may communicate directly with the computer system 10 in some embodiments. The database/memory 22 may be located locally such as within the same housing or in the same room as the computer system 10, or may be located at a location remote from the computer system 10 and accessible via, for example, the communications network 20.

The printer 24 may be used to print out images of or data representing simulated hearth objects such as a decorative heating appliance, and accessories for the heating appliance. In one embodiment, the printer 24 prints out true to life scale representations or images of a decorative heating appliance alone or in combination with, for example, heating appliance accessories, portions of a living space (e.g., a wall structure of a consumer's home), etc. Such true to life scale printouts could be helpful for consumers as well as retail and sales personnel because the printout can be transported easily and displayed at different locations with ease with a time delay and without other features of the system 8.

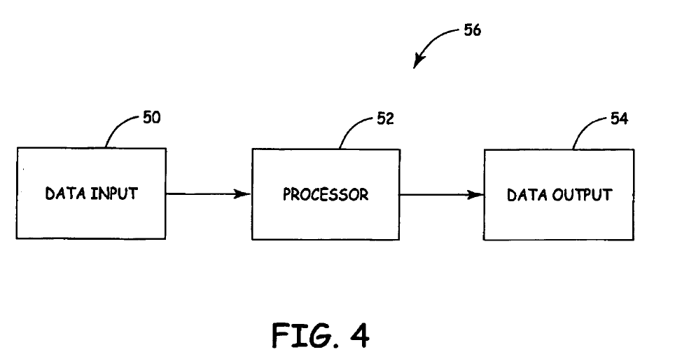

Referring now to FIGS. 4-6, aspects of several different systems providing the functions described herein are illustrated. FIG. 4 illustrates a system 56 that includes a data input 50, a processor 52, and data output 54. The data input includes information such as data representing hearth related objects such as decorative heating appliances, accessories for decorative heating appliances, and living spaces within which a decorative heating appliance is positioned and/or exposed. The data may be in the form of, for example, analog or digital images. The data may also includes lists of products or features, software, pricing information, compatibility related information, all of which may be provided in a desired format.

The processor 52 may include any desired analog or digital processing equipment and functionality. Preferably, the processor 52 is capable of evaluating data representing at least one hearth related object and outputting data about that object. More preferably, the processor is capable of combining data representing two or more hearth related objects such as, for example, data representing a decorative heating appliance with data representing an accessory of a heating appliance and/or data representing at least a portion of a living space.

The data handled or otherwise processed by the processor 52 may be output in many different forms as the data output 54. The data output may be formatted as display information used by a display device to generate a viewable image. The data output may include video, audio, two-dimensional, three-dimensional and other types of data and information related to the hearth related objects and living spaces associated with the hearth related products. The data output may be manipulated in any desired fashion to provide, for example, a desired display.

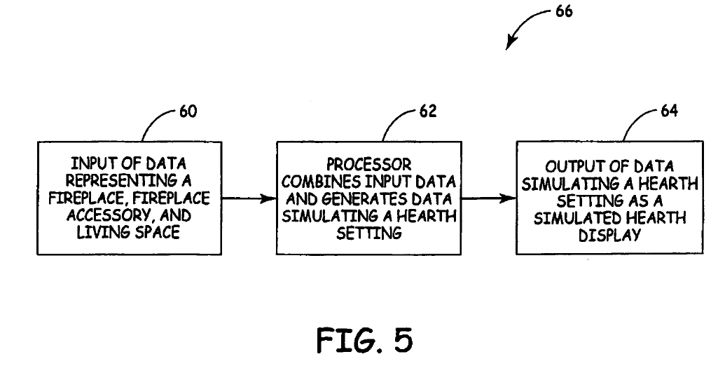

Referring now to FIG. 5, a more specific system 66 includes input 60 of data representing a fireplace, fireplace accessory, or living space, a processor 62 that combines input data and generates data simulating a hearth, and output 64 of data simulating a hearth setting as a simulated hearth display. While system 66 includes features related to a fireplace and a hearth setting and/or hearth display, the system 66 may be equally applicable to other types of decorative heating appliances and more general or specific types of displays.

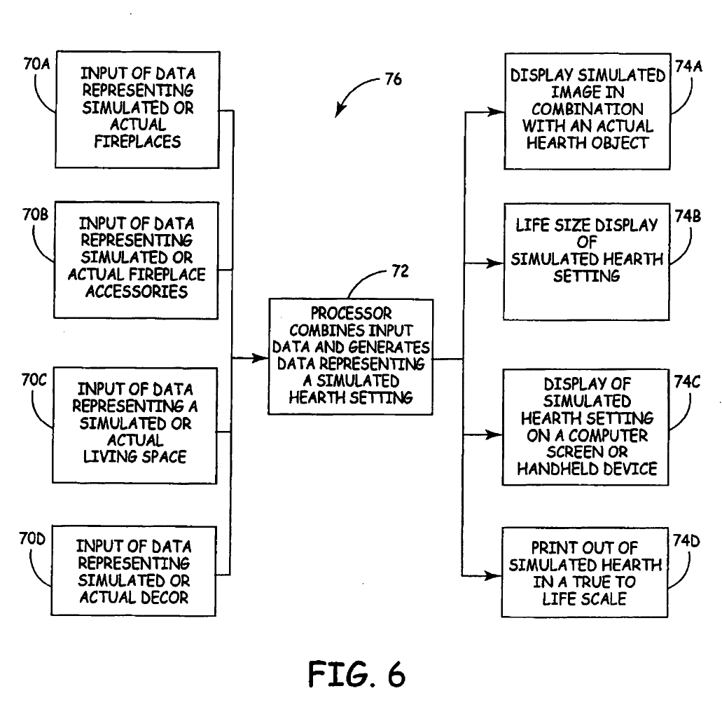

Referring to FIG. 6, a system 76 includes features 70A-D as inputs, a processor related feature 72, and features 74A-D as potential outputs. The inputs 70A-D include input 7A of data representing simulated or actual fireplaces, input 7B of data representing simulated or actual fireplace accessories, input 7C of data representing a simulated or actual living space, and input 7D of data representing simulated or actual decor. The fireplace and fireplace accessories noted in features 70A, 70B are merely exemplary of a particular type of decorative heating appliance. The living space and decor referenced in features 70C, 70D can be closely related. A living space, as defined above, may more generally include the structures that define the space (e.g., wall structures, floor structures, ceiling structures, etc.). The decor may be more applicable to decorative and functional pieces such as, for example, furniture, paint color, light fixtures, plants, tables, etc.

The processor feature 72 includes the processor combining input data and generating data representing a simulated hearth or living space. The output from the processor 72 results in one of the outputs 74A-D. Output 74A includes display of a simulated image in combination with an actual hearth object. Output 74B relates to a life size (true to life scale) display of a simulated hearth for example, in a retail store or in a consumer's living space. Output 74C relates to display of simulated hearth on a computer screen or handheld device. Output 74D relates to a printout of the simulated hearth in a reduced scale or in a true to life scale. Any of the inputs 70A-D can be used alone or in combination as inputs for the processor functions 72. Further, any combination of outputs 74A-D can be possible. The inputs 70A-D and outputs 74A-D as well as the processor functionality 72 can be altered, added to or reduced in scope or function to provide systems and functionality according to the inventive principles described herein.

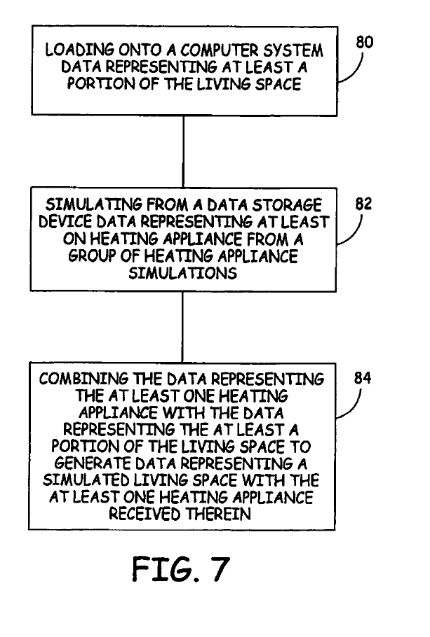

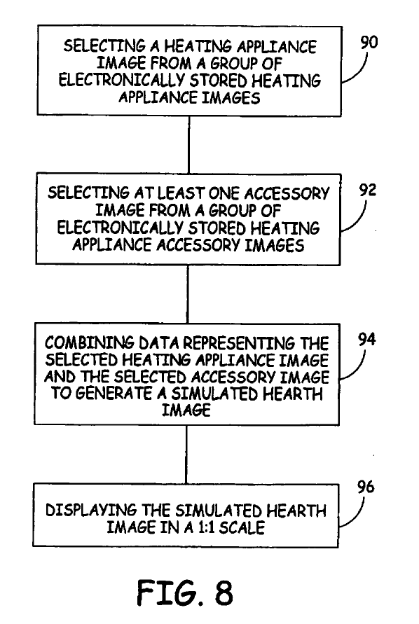

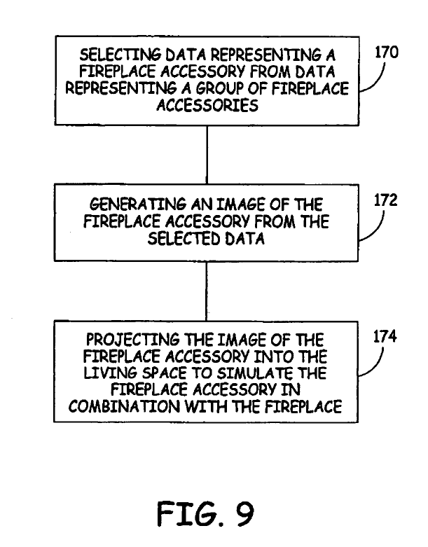

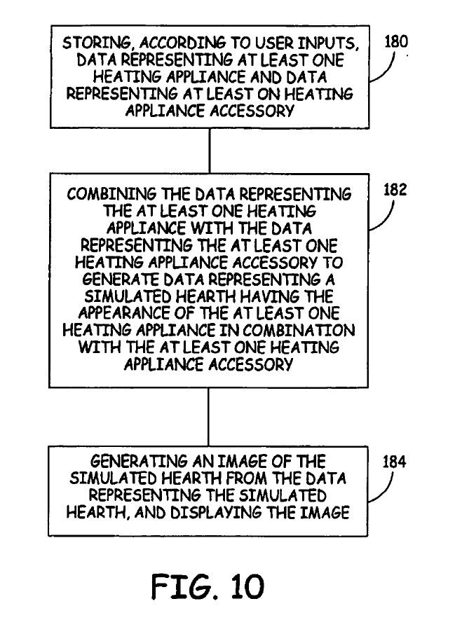

FIGS. 7-10 illustrate several exemplary processes/methods possible in view of the systems and methods described above. FIG. 7 relates to a method of simulating a living space that is capable of receiving a heating appliance according to steps 82, 84, 86. FIG. 8 relates to a method of displaying a simulated hearth image according to steps 92, 94, 96. FIG. 9 relates to a method of simulating fireplace accessories with a fireplace according to steps 172, 174, 176. FIG. 10 relates to steps provided by a computer readable medium having computer executable instructions for performing the steps according to steps 182, 184, 186.

A system and related methods that provide for visualization of a combination of hearth related features and/or the living spaces within which the hearth related features resides can be an effective way of helping individuals decide their preferred combination. By providing a database of data representing a plurality of different decorative heating appliances such as fireplaces, stoves, fireplace inserts as well as storing data related to accessories used with those decorative heating appliances, a consumer can mix and match these hearth related objects until a preferred combination is determined by the consumer.

The systems described herein are further capable of providing combinations of those hearth related objects (actual or simulated), with actual or simulated representations of a consumer's living space. For example, data representing a fireplace can be displayed as an image on a wall structure of a consumer's home to provide the consumer with a visual representation in two-dimension or three-dimension of what the actual fireplace will look like when installed in the consumer's home. In other embodiments, as described above, images of or data representing portions of the consumer's home (e.g., a digital photograph of a wall structure in a consumer's home) can be combined with images of or data representing a fireplace so that a simulated combination can be viewed by the consumer. Such a simulated representation of the combination of living space and fireplace can be viewed in a retail store, in the consumer's home, on a handheld device at any location, on the Internet, or in any desired medium or location. The systems and methods described herein provide for significant customization and flexibility as to when, where, and how data representing hearth related objects and living spaces are input, processed, and output.

The present invention should not be considered limited to the particular examples or materials described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. A method of simulating a living space capable of receiving a heating appliance, the method comprising:
loading onto a computer system data representing at least a portion of the living space;
selecting from a data storage device data representing at least one heating appliance from a group of heating appliance simulations; and
combining the data representing the at least one heating appliance with the data representing the at least a portion of the living space to generate data representing a simulated living space with the at least one heating appliance received therein.

2. The method of claim 1, further comprising displaying the simulated living space with the at least one heating appliance received therein.

3. The method of claim 2, wherein the displayed simulated living space provides is a 1:1 true to life image of the at least one heating appliance.

4. The method of claim 2, wherein the simulated living space is displayed on at least one of a handheld device, a monitor, and a portion of a living space.

5. The method of claim 1, further comprising printing the simulated living space with the at least one heating appliance received therein with 1:1 true to live dimensions.

6. The method of claim 1, further comprising selecting from a data storage device data representing at least one heating appliance surround from a group of heating appliance surround simulations, and combining the data representing the at least one heating appliance surround with the data representing the at least a portion of the living space to generate a simulated living space with the at least one heating appliance surround received therein.

7. The method of claim 1, further comprising selecting from a data storage device data representing at least one heating appliance mantle from a group of heating appliance mantle simulations, and combining the data representing the at least one heating appliance mantle with the data representing the at least a portion of the living space to generate a simulated living space with the at least one heating appliance mantle received therein.

8. The method of claim 2, wherein displaying the simulated living space with the at least one heating appliance received therein includes a video display.

9. A fireplace simulation system, comprising:
data storage configured to store data representing at least one heating appliance and at least one heating appliance accessory;
a processor configured to combine data representing the at least one heating appliance and the at least one heating appliance accessory, and configured to generate data representing a simulated hearth; and
a display device configured to display the simulated hearth.

10. The system of claim 9, wherein the display device is selected from a group comprising a handheld device, a monitor, a television, and a projector.

11. The system of claim 9, wherein the processor is configured to combine data representing at least a portion of living space with the data representing the at least one heating appliance and the at least one heating appliance accessory.

12. The system of claim 9, wherein the at least one heating appliance is selected from a group comprising a fireplace, a stove, and a fireplace insert.

13. The system of claim 12, wherein the at least one heating appliance accessory is selected from a group comprising a surround, a mantel, and a set of doors.

14. The system of claim 9, further comprising a light generating member configured to alter lighting conditions associated with the displayed simulated hearth.

15. The system of claim 9, wherein the display device includes a holographic screen to provide a three dimensional appearance of the simulated hearth.

16. The system of claim 9, further comprising a video module and a sound generating module that display the simulated hearth in motion with sound.

17. A method of displaying a simulated hearth image, the method comprising:
selecting a heating appliance image from a group of electronically stored heating appliance images;
selecting at least one accessory image from a group of electronically stored heating appliance accessory images;
combining data representing the selected heating appliance image and the selected accessory image to generate a simulated hearth image; and
displaying the simulated hearth image in a 1:1 scale.

18. The method of claim 17, wherein the group of stored heating appliance accessory images includes images of at least one of a surround and a mantle.

19. The method of claim 17, further comprising printing the simulated hearth image in a 1:1 scale of an actual heating appliance represented by the selected heating appliance image and an actual heating appliance accessory represented by the selected heating appliance image.

20. A method of simulating fireplace accessories with a fireplace, the fireplace being exposed in a living space, the method comprising:
selecting data representing a fireplace accessory from data representing a group of fireplace accessories;
generating an image of the fireplace accessory from the selected data; and
projecting the image of the fireplace accessory into the living space to simulate the fireplace accessory in combination with the fireplace.

21. The method of claim 20, wherein the group of fireplace accessory image includes at least one of a fireplace surround, fireplace doors, and a mantle.

22. A computer-readable medium having computer-executable instructions for performing steps comprising:
storing, according to user inputs, data representing at least one heating appliance and data representing at least one heating appliance accessory; and
combining the data representing the at least one heating appliance with the data representing the at least one heating appliance accessory to generate data representing a simulated hearth having the appearance of the at least one heating appliance in combination with the at least one heating appliance accessory.

23. The computer-readable medium of claim 22, having further computer-executable instructions for performing the steps of generating an image of the simulated hearth from the data representing the simulated hearth, and displaying the image.

24. The computer-readable medium of claim 22, having further computer-executable instructions for performing the steps of generating a video that includes the simulated hearth from the data representing the simulated hearth, and displaying the video.

25. The computer-readable medium of claim 22, having further computer-executable instructions for performing the steps of storing data representing at least a portion of a living space, combining the data representing the at least a portion of a living space with the data representing the simulated hearth, generating an image from the combined data, and displaying the image.
